(19) United States
(12) Patent Application Publication
(10) Pub. No.: US 2007/0244212 A1
(43) Pub. Date: Oct. 18, 2007

(54) Modified Perfluoroplastics, and Method for The Production Thereof

(76) Inventor: Dieter Lehmann, Coswig (DE)

Correspondence Address: GREENBLUM & BERNSTEIN, P.L.C., 1950 ROLAND CLARKE PLACE, RESTON, VA, 20191, US

(21) Appl. No.: 10/577,300

(22) PCT Filed: Oct. 22, 2004
(86) PCT No.: PCT/EP04/52621

§ 371 Date: Jan. 25, 2007

(30) Foreign Application Priority Data
Oct. 30, 2003 (DE) 103 51 812.6

(51) Int. Cl. C08F 259/08; C08F 291/18; C08F 8/00; C08F 8/06

(52) U.S. Cl. 522/116; 522/114; 522/120; 522/129

(57) ABSTRACT

Modified perfluoroplastics and method for the production thereof. The invention relates to the field of chemistry and relates to modified perfluoroplastics that can be used, for example, in tribomaterials, and a method for the production thereof. Modified perfluoroplastics which, when processed in structural parts, lead to comparable gliding properties and improved wear resistances, and furthermore there is provided a simple and efficient method for production thereof. Modified perfluoropolymers are provided, the surface of which simultaneously exhibit —COOH and/or COF groups and reactive perfluoroalkyl-(peroxy-) radical centers, whereby further low-molecular and/or oligomeric and/or polymeric substances and/or olefinically unsaturated monomers and/or oligomers and/or polymers are coupled via the groups and/or to the centers. There is also provided a method for producing modified perfluoroplastics in which modified perfluoropolymers, which simultaneously exhibit —COOH and/or —COF groups and reactive perfluoroalkyl-(peroxy-) radical centers, are reacted with other substances through substitution reactions and/or addition reactions and/or radical reactions.

The invention relates to the field of chemistry and relates to modified perfluoroplastics that can be used, for example, in tribomaterials, and a method for the production thereof.

“In the search for polymer materials appropriate for building nuclear reactors, it was determined that PTFE, in contrast to its high chemical and thermal stability, is extraordinarily sensitive to radiation. Under inert conditions as well as in the present of oxygen, it even decomposes at low absorbed doses, becomes brittle even at 0.2 to 0.3 kGy and crumbly at <100 kGy . . . .

Beginning at approximately 360° C., the purely radiochemical decomposition is noticeably overlaid by a thermal decomposition . . . .

Due to the stochastic progression of the radiochemical decomposition, reaction products form with a wide spectrum of chain lengths . . . .

If PTFE is irradiated in the presence of oxygen, peroxy and alkoxy radicals are formed from the perfluoroalkyl radicals that initially formed . . . .

In the course of the intermediate stage of the formation of the alkoxy radical, the perfluoroalkyl radical end group is decomposed in stages by shortening the chains and formation of carbonyldifluoride . . . .

In contrast, perfluoroalkanic acid fluorides and perfluoroalkyl radical end groups form from the alkoxy radical side groups . . . .

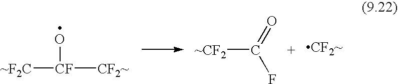

Perfluorized diacids are also formed in very small quantities because two radical center side groups can also form on a perfluorcarbon chain . . . .

Unsintered and unpressed PTFE emulsion and suspension polymers are of a fibrous-felted character. A transfer, for example, of the anti-adhesive and sliding characteristics of PTFE to other media by integration into aqueous or organic dispersions, polymers, dyes, lacquers, resins, or lubricants is not possible because this PTFE cannot be homogenized, but rather tends to form clumps, agglomerates, floods, or settles.

By means of the effect of high-energy radiation with an absorbed dose of approximately 100 kGy, a pourable fine powder is obtained from the fibrous-felted polymers as a result of the partial decomposition of the polymer chains. This powder still contains loose agglomerates that can be easily separated into primary particles with a particle diameter of <5 μm. In the case of irradiation in the presence of reactants, functional groups are formed into the polymer. If the irradiation occurs in air, then according to Eq. (9.22) (and subsequent hydrolysis of the —COF groups by means of moisture in the air), carboxyl groups result. If, before irradiation, (NH₄)₂SO₃ is mixed in, then groups containing S are to be attained. These functional groups reduce the hydrophobia and organophobia of the PTFE so substantially that the resulting fine powder can be easily homogenized with other media. The positive characteristics of PTFE, such as its excellent gliding, separating, and dry lubrication characteristics as well as its high chemical and thermal stability, are maintained. Carboxyl and sulfonic acid groups to which perfluorized chains are connected also have a high degree of chemical inertness . . . .

Because of the insolubility of the PTFE and its decomposition products (with the exception of the very low-molecular products), the conventional methods of determining molar mass cannot be used. The determination of molar mass must occur in an indirect manner.” [A. Heger et al., Technologie der Strahlenchemie an Polymeren, Akademie-Verlag Berlin 1990].

The incompatibility with other materials often has a negative effect. By chemically activating PTFE using the known methods with (1) sodium amide in liquid ammonia and (2) alkali alkyl and alkali aromatic compounds in aprotic inert solvents, a modification can be achieved. By means of these modifications, boundary surface interactions can be achieved that are reactive or even only improved by adsorptive forces.

Recycling of the products of PTFE decomposition occurs in various fields of use, also as an additive to plastics for the purpose of achieving gliding or anti-adhesive characteristics. The fine powder substances are more or less finely dispersed as filler components in a matrix [Ferse et al., Plaste u. Kautschuk, 29 (1982), 458; Ferse et al. DD-PS 146 716 (1979)]. In releasing the matrix components, the PTFE fine powder can be eliminated and/or is recovered.

Although, in the areas of use of PTFE fine powder, an improvement of the characteristics is achieved as compared to the commercial fluorocarbon-free additives, the incompatibility, the insolubility, the loose coupling, and also heterogeneous distribution is disadvantageous for many areas of use.

Furthermore, grafted plastics containing fluorine are known (U.S. Pat. No. 5,576,106) comprising plastic particles containing fluorine, on the surface of which a non-homopolymerized ethylenically unsaturated compound is grafted. The non-homopolymerized ethylenically unsaturated compounds can thereby be acids, esters or anhydrides.

These grafted plastics containing fluorine are produced by exposing the plastic powder containing fluorine produced by means of a melting process to a source of ionizing radiation in the presence of the ethylenically unsaturated compound. The bonding of the ethylenically unsaturated compounds thereby occurs on the surface of the plastic particles containing fluorine.

The object of the invention is to disclose modified perfluoroplastics that result in comparable gliding properties and improved wear resistances when processed in structural parts, a greater durability of the parts thus being achievable, and furthermore a simple and efficient method for producing such modified perfluoroplastics.

The object is attained through the invention described in the claims. Further developments are the subject matter of the subordinate claims.

The modified perfluoroplastics comprise perfluoropolymers radiation-chemically and/or plasma-chemically modified under the influence of oxygen, the surface of which perfluoropolymers simultaneously exhibit —COOH and/or —COF groups and reactive perfluoroalkyl-(peroxy-) radical centers, additional low-molecular and/or oligomeric and/or polymeric substance(s) and/or olefinically unsaturated monomer(s) and/or olefinically unsaturated oligomer(s) and/or olefinically unsaturated polymer(s) or mixtures thereof being coupled via some or all of the groups and/or to some or all of the centers through subsequent reactions.

Advantageously, the perfluoropolymer is radiation-chemically modified under the influence of oxygen with a radiation dose greater than 50 kGy, even more advantageously greater than 100 kGy.

Likewise advantageously PTFE is used as the perfluoropolymer.

It is also advantageous that the subsequent reactions are radical reactions and/or substitution reactions and/or addition reactions.

It is also advantageous if olefinically unsaturated monomers and/or olefinically unsaturated oligomer(s) or olefinically unsaturated polymer(s) are coupled to the reactive perfluoroalkyl-(peroxy-) radical centers by (co-)polymerization and/or by grafting.

It is likewise advantageous if substances are coupled to the ester and/or amide groups produced, to which advantageously at least one further functional group is bonded, via reactions with the —COOH and/or —COF groups.

It is furthermore advantageous if, via reactions with the —COOH— and/or —COF groups, aliphatic amino compounds and/or aromatic amino compounds and/or alkylaryl-amino compounds are coupled to at least one further primary and/or secondary amino group or at least one further reactive or reactively modifiable or reactively activatable functional group.

It is also advantageous if as a further reactive or reactively modifiable or reactively activatable functional group, carboxylic acid anhydride, carboxylic acid anhydride derivative, which can also be recycled as dicarboxylic acid and/or carbonic acid half-ester compound to anhydride, —COOH, —CO-halogen, —COOR, —CO—OOR, —O—CO—OR, —SO₃H, —SO₂NRR*, —SO₂N₃, —SO₂-halogen, aliphatic and/or aromatic —OH, aliphatic and/or aromatic —SH, (meth-)acrylic ester, (meth-) acrylamide derivate, (meth-)allyl and other olefinically unsaturated polymerizable compounds and/or polymers, cyanohydrin, —NCO, —NH—CO—OR, —NH—CS—OR, —NR*—CO—NR**R***, —NR*—CS—NR**R***, —CHO, —COR are coupled, whereby R, R*, R** and/or R*** mean alkyl-Xₘ, aryl-Xₙ or alkyaryl-X_{O} or whereby R, R*, R** and/or R*** bonded to N can also mean H, and whereby X mean the same or also different functional groups and with m, n and o mean with numbers greater than/equal to 0.

It is also advantageous if olefinically unsaturated monomers and/or olefinically unsaturated oligomers and/or olefinically unsaturated polymers are coupled to the reactive perfluoroalkyl-(peroxy-) radical centers through (co-) polymerization and/or through grafting and substance(s) are coupled to the ester- and/or amide compounds produced via reactions with the —COOH and/or —COF groups, and aliphatic amino compounds and/or aromatic amino compounds and/or alkylaryl-amino compounds are coupled to at least one other primary and/or secondary amino group or at least one other reactive or reactively modifiable or reactively activatable functional group via reactions with the —COOH and/or —COF groups.

With the method according to the invention for producing modified perfluoroplastics, perfluoropolymers radiation-chemically or plasma-chemically modified under the influence of oxygen, which perfluoropolymers simultaneously exhibit —COOH and/or —COF groups and reactive perfluoroalkyl-(peroxy-) radical centers, are reacted with low-molecular and/or oligomeric and/or polymeric substances and/or olefinically unsaturated monomer(s) and/or olefinically unsaturated oligomer(s) and/or olefinically unsaturated polymer(s) by means of substitution reactions and/or by means of addition reactions and/or by means of radical reactions.

Advantageously, the perfluoropolymer is modified radiation-chemically with a radiation dose greater than 50 kGy, even more advantageously with a radiation dose greater than 100 kGy.

Further advantageously, PTFE in compact or powder form is used as the perfluoropolymer.

Likewise advantageously, the radiation-chemically modified perfluoropolymer is treated as powder by subsequent tempering at low temperatures, still more advantageously under air yielding the —COF groups and the reactive perfluoroalkyl-(peroxy-)radical centers.

It is advantageous if the radiation-chemically modified perfluoropolymer is reacted with olefinically unsaturated monomer(s) and/or olefinically unsaturated oligomer(s) and/or olefinically unsaturated polymer(s).

It is also advantageous if the —COOH and/or —COF groups are reacted at temperatures >150° C. with low-molecular and/or oligomeric and/or polymeric substance(s) that contain primary and/or secondary amino groups and/or hydroxy groups and/or amide groups and/or urea groups and/or isocyanate groups and/or blocked/protected isocyanate groups and/or urethane groups and/or uretdione groups, with at least one other functional group in the (macro-) molecule, which are capable of chemical consecutive reactions.

It is furthermore advantageous if the —COOH and/or —COF groups are reacted at temperatures >150° C. in a reaction with low-molecular and/or oligomeric and/or polymeric substance(s) that contain primary and/or secondary amino groups and/or hydroxy groups, with at least one other functional group in the (macro-) molecule, which are capable of chemical consecutive reactions.

It is furthermore advantageous if the —COOH and/or —COF groups are reacted at temperatures >150° C. in a reaction with low-molecular and/or oligomeric and/or polymeric substance(s) that contain hydroxy groups and/or epoxy groups, with at least one other functional group in the (macro-) molecule, which are capable of chemical consecutive reactions.

It is likewise advantageous if the —COF groups are reacted with a lactam compound or an alcohol compound.

It is also advantageous if the —COOH and/or —COF groups are reacted at temperatures ≧200° C. with low-molecular and/or oligomeric and/or polymeric substance(s) that contain amide groups and/or urea groups and/or isocyanate groups and/or blocked/protected isocyanate groups and/or urethane groups and/or uretdione groups, with at least one other functional group in the (macro-) molecule, which are capable of chemical consecutive reactions.

It is likewise advantageous if the radiation-chemically modified perfluoropolymer powder is reacted with reactive perfluoroalkyl-(peroxy-)radical centers with olefinically unsaturated monomers and/or olefinically unsaturated oligomers and/or olefinically unsaturated polymers, and the —COOH and/or —COF groups are reacted at temperatures >150° C. with low-molecular and/or oligomeric and/or polymeric substances that contain primary and/or secondary amino groups and/or hydroxy groups and/or amide groups and/or urea groups and/or isocyanate groups and/or blocked/protected isocyanate groups and/or urethane groups and/or uretdione groups, with at least one other functional group in the (macro-)molecule, which are capable of chemical consecutive reactions, or the —COOH and/or —COF groups are reacted at temperatures >150° C. in a reaction with low-molecular and/or oligomeric and/or polymeric substances that contain hydroxy groups and/or epoxy groups, with at least one other functional group in the (macro-)molecule, which are capable of chemical consecutive reactions, or the —COF groups are reacted with a lactam compound or an alcohol compound.

With the advantageously radiation-chemical modification of perfluoropolymer, are formed of the reactive perfluoroalkyl-(peroxy-)radical centers which surprisingly are capable of the coupling of monomer(s) and/or polymer(s) through radical reactions, which substitution reactions and/or addition reactions. With a plasma treatment, superficially similar reactive perfluoroalkyl-(peroxy)radical centers can be produced and used for this coupling reaction; however, these reactive perfluoroalkyl-(peroxy-)radical centers are not optimal in their distribution and density compared to the reactive perfluoroalkyl-(peroxy-)radical centers produced radiation-chemically. Thus, after the PTFE micropowder modification with monomers in solution after the separation and purification of this PTFE micropowder, a chemical coupling of homopolymers, copolymers or terpolymers, depending on the adjustment of the modification charge, could be proven by means of infrared spectroscopy, i.e., the polymer chains were no longer detachable via extraction from the PTFE. Compared to PTFE micropowders without reactive perfluoroalkyl-(peroxy-)radical centers or also in the presence of uncombined radical initiators, no modified PTFE micropowders were formed; the PTFE micropowder could be separated quantitatively and unchanged in substance.

With the solution according to the invention, monomers and/or polymers or mixtures thereof can be grafted/chemically coupled to the reactive perfluoroalkyl-(peroxy-)radical centers and —COOH and/or —COF groups simultaneously present.

According to the grafted graft branch structure, it is respectively possible for one skilled in the art to deduce whether the bonding/compatibilization of these modified perfluoroplastics with the matrix is realized via a compatibilization and/or in a subsequent chemical reaction/modification with polymers, which leads to an improvement of the material and sliding friction properties and an increase of the wear resistance compared to the unmodified base materials and the physical mixtures of pure perfluoropolymer and plastics.

One particular advantage of the solution according to the invention is that polymers can be coupled to the substances coupled via an ester and/or amide bond to the modified perfluoroplastics with at least one other reactive or reactively modifiable or reactively activatable functional group and/or polymer chains can be coupled to the modified perfluoroplastic, preferably as a powder, via a polymer build-up reaction of low-molecular substances, which lead to an improvement of the material properties and to the increase of the wear resistance compared to the unmodified base materials and the physical mixtures with pure perfluoroplastics.

To improve the wear resistance, it is further advantageous to use the modified perfluoroplastics that are coupled with monomers and/or polymers or mixtures thereof simultaneously as storage medium for PFPE additives (PFPE—perfluoropoly ether), which is incompatible with the matrix and helps to reduce the friction coefficient while at the same time increasing the wear resistance.

The modified perfluoroplastics according to the invention are produced according to the invention in that, for example, PTFE emulsion polymer (TF 2025 from Dyneon) and PTFE suspension polymer (TF 1750 from Dyneon) are irradiated in air with 500 kGy. Reactive PTFE radical centers and —COOH and/or —COF groups are produced during the irradiation in 50-kGy steps under the influence of oxygen for decomposition into a PTFE micropowder. These reactive PTFE radical centers are eliminated according to the prior art by tempering at higher temperatures, since this serves to stabilize the PTFE micropowder. Likewise the —COF groups were largely converted during tempering to the —COOH groups through the influence of the air humidity.

According to the present invention, the tempering is carried out only at low temperatures and under air such that the reactive perfluoroalkyl-(peroxy-)radical centers and available —COF and —COOH groups are conserved as completely as possible. The perfluoroalkyl-(peroxy-)radical centers can be used in a targeted manner for the coupling with radical reactions with olefinically unsaturated monomers and/or oligomers and/or polymers for grafting. The —COF and/or —COOH groups can be used via addition and/or substitution reactions in a targeted manner for the coupling of agents/substances that have at least one other reactive or reactively modifiable or reactively activatable functional group. The monomers and/or polymers that can be coupled to the reactive perfluoroalkyl-(peroxy-)radical centers formed and the substances that can be coupled to —COOH and/or —COF groups can be provided with (di- or poly-) functional, with the same or different reactive groups, whereby of them functional groups can also be suitable for consecutive reactions for the (surface) modification of the perfluoroplastics, preferably as powder. The coupling of these monomers and/or oligomers and/or polymers can thereby be carried out in dispersion or in substance or during the melt modification/melt processing in the melt. In this manner radically coupled perfluoroplastics can be produced.

By dispersion is meant according to the invention that a perfluoropolymer powder or perfluoroplastic powder is present undissolved in a liquid and the monomer (mixture) forms the liquid or is present dissolved in the liquid. With a deficit of liquid, the dispersion can also be present as a pasty mass.

A radical coupling/reactive reaction in substance means that a perfluoropolymer powder or perfluoroplastic powder is reacted as a swirled or fluidized powder advantageously under inert gas in the presence of a monomer (mixture) to the modified perfluoroplastic according to the invention as a powder.

In addition to the PTFE, all the other perfluoropolymer compounds that form and have reactive perfluoroalkyl-(peroxy-)radical centers and —COOH and/or —COF groups in a radiation and/or plasma modification under the influence of oxygen can be used according to the invention and modified/reacted after an irradiation and/or plasma treatment. Perfluoropolymer compounds should mean all perfluorinated oligomers and polymers without hydrogen atoms in the main and side chain except the protons on the carboxylic acid function as —COOH, whereby a part of the C—C bonds can also be realized via an ether bridge. These include, for example, PTFE (polytetrafluoroethylene), FEP (poly[tetrafluoroethylene-co-hexafluoropropylene]) and PFA (poly[tetrafluoroethylene-co-perfluoropropylvinylether]), and Teflon®AF (DuPont) and Cytop®, as a special subgroup of the fluoropolymers.

Of course, the reaction can also take place in the melt or in solution only with such radiation-modified and/or plasma-modified perfluoropolymers that dissolve or can be converted into a melt and thus can be reacted with the low-molecular substances and/or oligomers and/or polymers.

Through the coupling, the perfluoroplastics modified through radical reactions and/or through substitution reactions and/or through addition reactions exhibit improved mechanical and tribological properties after incorporation into a matrix. The use of the modified perfluoroplastics according to the invention is of interest above all in processes in which sliding friction processes are involved. A good bond and an improvement of the wear resistance is achieved through the coupling realized through radical reactions and/or through substitution reactions and/or through addition reactions and or compatibilization with the matrix material, since the PTFE grain cannot be ground out of the matrix material with mechanical load.

Since the advantageously modified PTFE substance/monomer/polymer compounds either are in direct interaction with the matrix with graft polymer branches and/or have been brought into direct interaction with the matrix via chemical bonds through reaction, compared to the physical mixtures, improved material properties are also observed, depending on the degree of bonding.

With the solution according to the invention new materials are obtained that exhibit improved wear resistances, i.e., increased durability in the applications, with comparable sliding friction coefficients. Furthermore, a further reduction of the sliding friction coefficient and a noticeable improvement of the wear resistance is obtained through the addition of perfluorinated oils such as PFPE (perfluoropoly ether), whereby the advantageously modified PTFE monomer/polymer compounds according to the invention additionally act as a storage medium.

The invention is described below in more detail on the basis of several exemplary embodiments

### COMPARATIVE EXAMPLE 1

PTFE micropowder with styrene and oligoamide

In a liter flask 100 g PTFE polymer (Zonyl MP 1600—polymer unirradiated, DuPont, untreated) is dispersed/stirred in 500 ml ε-caprolactam at 100° C., degassed and rinsed with pure nitrogen. 50 ml (freshly distilled) styrene is added to the PTFE-ε-caprolactam dispersion at 100° C. and stirred for 4 hours. Subsequently, the batch is heated to 240° C. while being stirred for 4 hours. The ε-caprolactam thereby serves as a solvent.

The solid from the dispersion is separated and alternately thoroughly washed first with DMAc and then with formic acid. After the procedure has been carried out several times, it is washed with methanol and dried.

The infrared evaluation of the separated, purified PTFE micropowder showed that only pure/unmodified PTFE was detectable in the infrared spectrum with the unirradiated and untreated PTFE micropowder, i.e., no grafting or coupling reaction took place. The PTFE materials at 10% by weight were incorporated into SEBS and also into PA-6 in the laboratory kneader and the tribological properties were examined. These materials were used as reference substances for the tribological examinations.

### EXAMPLE 1

Modification of irradiated PTFE emulsion polymer with styrene and oligoamide

Experimental procedure and workup were carried out analogously to comparative example 1; however, 100 g PTFE emulsion polymer (TF 2025 from Dyneon) was used, which was irradiated with 500 kGy.

The infrared spectroscopic examination of the purified solid product resulted in very high polystyrene and high (oligo-/poly-)amide absorptions in addition to the PTFE as proof of the chemical coupling between PTFE, polystyrene and oligo-/polyamide. In comparative example 1 only pure PTFE was detectable in the infrared spectrum.

The PTFE material thus modified was incorporated at 10% by weight into SEBS in the laboratory kneader and the tribological properties were examined. In a first approximation the friction coefficients in the block/ring test were comparable to comparative example 1; in contrast, the modified PTFE material in the compound with SEBS showed a marked reduction of the wear value to 55% compared to the physical mixture with SEBS (comparative example 1).

### EXAMPLE 2

Modification of irradiated PTFE suspension polymer with styrene and oligoamide Performance of the test and workup were carried out analogously to comparative example 1, however, 100 g PTFE suspension polymer (TF 1750 from Dyneon) was used, which was irradiated with 500 kGy.

The infrared spectroscopic examination of the purified solid product resulted in polystyrene and high (poly-)amide absorptions in addition to the PTFE as proof of the chemical coupling between PTFE, polystyrene and oligo4polyamide. In comparative example 1 only pure PTFE was detectable in the infrared spectrum.

The PTFE material thus modified was incorporated at 10% by weight into PA-6 in the laboratory kneader and the tribological properties were examined. In a first approximation the friction coefficients in the block/ring test were comparable with comparative example 1; in contrast, the modified PTFE material in the compound with PA-6 showed a reduction of the wear value to 45% compared to the physical mixture with PA-6 (comparative example 1).

### EXAMPLE 3

Modification of plasma-treated PTFE polymer with styrene and oligoamide

Performance of the test and workup were carried out analogously to comparative example 1, however, 100 g PTFE polymer (Zonyl MP 1600—polymer unirradiated, DuPont, plasma-treated) was used.

The infrared spectroscopic examination of the purified solid product resulted in very high polystyrene and (poly-)amide absorptions in addition to the PTFE as proof of the chemical coupling between PTFE, polystyrene and oligo-/polyamide. In comparative example 1 only pure PTFE was detectable in the infrared spectrum.

The PTFE material thus modified was incorporated at 10% by weight into SEBS in the laboratory kneader and the tribological properties were examined. In a first approximation the friction coefficients in the block/ring test were comparable to the comparative example 1; in contrast, the modified PTFE material in the compound with SEBS showed a reduction of the wear value to 75% compared to the physical mixture (comparative example 1).

### EXAMPLE 4

Modification of irradiated PTFE emulsion polymer—mixture of styrene and maleic anhydride and subsequent reaction with ε-caprolactam.

In a liter flask 100 g of the PTFE emulsion polymer freshly electron-irradiated under the influence of oxygen (TF 2025 from Dyneon, irradiated with 500 kGy) is dispersed/stirred in 500 ml NMP at room temperature, degassed and rinsed with high-purity nitrogen.
(a) The dispersion is heated to 100° C. 25 ml styrene and 25 g maleic anhydride is incorporated and stirred for 4 hours. Subsequently, 50 g ε-caprolactam is incorporated, the temperature is increased during stirring to 200° C. and stirred for 8 hours. The solid from the dispersion is separated, washed with methanol and dried.
(b) The dispersion is heated to 100° C. 25 ml styrene and 25 g maleic anhydride is incorporated and stirred for 4 hours. The solid from the dispersion is separated and washed thoroughly with DMAc. Subsequently, 300 g melted ε-caprolactam is added to the product and stirred at 240° C. for 8 hours, the solid is separated and washed with methanol and dried.

The infrared evaluation of the separated, purified, modified PTFE powder yielded in (a) as well as in (b) chemically coupled PTFE-{styrene-N(ε-caproic acid)maleimide}-oligoamide-terpolymer in addition to the PTFE absorptions.

The PTFE materials thus modified were incorporated at 10% by weight into PA-6 in the laboratory kneader and the tribological properties were examined. In a first approximation the friction coefficients in the block/ring test were comparable to comparative example 1; in contrast, the modified PTFE materials in the compound with PA-6 showed a reduction of the wear value to 60% compared to the physical mixture with PA-6 (comparative example 1).

### COMPARATIVE EXAMPLE 2

PTFE micropowder with ε-caprolactam

In a liter flask 100 g of the PTFE micropowder (TF 9205, thermally decomposed, Dyneon) is dispersed/stirred in 500 ml ε-caprolactam in a melt/solution, degassed and rinsed with high-purity nitrogen. The dispersion is heated to 250° C. and stirred for 8 hours.

The solid is separated and thoroughly washed with DMAC and then with methanol and dried.

The infrared evaluation of the separated, purified PTFE micropowder showed that only pure PTFE was detectable in the infrared spectrum, i.e., no reaction between PTFE and the ε-caprolactam took place.

After the incorporation of 15% by weight of the PTFE micropowder into an epoxide resin and after the cross-linking in the form of a plate and production of test specimens, tribological examinations were carried out in the block/ring test. This material was used as a reference substance for the tribological examinations.

### EXAMPLE 5

Modification of irradiated PTFE emulsion polymer with ε-caprolactam

Performance of the test and workup were carried out analogously to comparative example 2, however, 100 g PTFE emulsion polymer (TF 2025 from Dyneon, irradiated with 500 kGy) was used.

The infrared examination of the separated, purified PTFE powder showed that chemically coupled PTFE oligoamide graft copolymer was present, i.e., a reaction took place between PTFE and the ε-caprolactam. Amide absorptions were present in the infrared in addition to the PTFE with simultaneous disappearance of the —COOH and —COF absorptions in the spectrum. In comparative example 2, i.e., in the batch with unirradiated and untreated PTFE micropowder, only pure PTFE was detectable in the infrared spectrum.

After the incorporation of 15% by weight of modified PTFE micropowder into an epoxide resin and after the cross-linking in the form of a plate and production of test specimens, tribological examinations were carried out in the block/ring test. The tribological examinations showed that the chemically modified PTFE oligoamide material has comparable sliding friction coefficients to the physical mixture, but that an increased wear resistance can be observed. The wear in the block/ring test with the chemically coupled material showed a reduction of the wear to 55% compared to the material in comparative example 2.

### EXAMPLE 6

Modification of irradiated PTFE suspension polymer with ε-caprolactam

Performance of the test and workup were carried out analogously to comparative example 2, however, 100 g PTFE suspension polymer (TF 1750 from Dyneon, irradiated with 500 kGy) was used.

The infrared examination of the separated, purified PTFE micropowder showed that chemically coupled PTFE oligoamide graft copolymer was present, i.e., a reaction took place between PTFE and the ε-caprolactam. Amide absorptions were present in the infrared in addition to the PTFE with simultaneous disappearance of the —COOH and —COF absorptions in the spectrum. In comparative example 2, i.e., in the batch with unirradiated and untreated PTFE micropowder, only pure PTFE was detectable in the infrared spectrum.

After the incorporation of 15% by weight of modified PTFE micropowder into an epoxide resin and after the cross-linking in the form of a plate and production of test specimens, tribological examinations were carried out in the block/ring test. The tribological examinations showed that the chemically modified PTFE oligoamide material has comparable sliding friction coefficients to the physical mixture, but that an increased wear resistance can be observed. The wear in the block/ring test with the chemically coupled material showed a reduction of the wear to 65% compared to the material in comparative example 2.

### EXAMPLE 7

Modification of PTFE emulsion polymer with ε-caprolactam and GMA

In a liter flask 100 g of the PTFE micropowder [PTFE emulsion polymer (TF 2025, from Dyneon, irradiated with 500 kGy)] is dispersed/stirred in 500 ml ε-caprolactam in a melt/solution, degassed and rinsed with high-purity nitrogen.

The dispersion is heated to 250° C. and stirred for 8 hours. The dispersion is cooled down to 100° C. and catalytic amounts of 2-methylimidazol, 2 g stabilizer and 20 g glycidyl methacrylate (GMA) are added and stirred for another 4 hours exposed to nitrogen. The solid is separated and thoroughly washed with DMAc and then with methanol and dried. The infrared evaluation of the separated, modified PTFE micropowder yielded chemically coupled PTFE oligomide, to which GMA was coupled. In a copolymerization with styrene with the addition of a radical chain starter it was possible to detect a grafting/coupling with polystyrene via infrared. In a comparative examination of the product that after the thermal treatment 8 hours at 250° C., a styrene coupling on the PTFE micropowder was not detectable.

The PTFE material thus modified was incorporated at 10% by weight into SEBS in the laboratory kneader and the tribological properties were examined. In a first approximation the friction coefficients in the block/ring test were comparable with comparative example 1; in contrast, the modified PTFE material in the compound with SEBS showed a reduction of the wear value to 70% compared to the physical mixture (comparative example 1).

### EXAMPLE 8

Modification of PTFE emulsion polymer GMA

In a liter flask 100 g of the PTFE emulsion polymer (TF 2025 from Dyneon, irradiated with 500 kGy) is dispersed/stirred in 500 ml DMAc in a melt/solution, degassed and rinsed with high-purity nitrogen.

20 ml glycidyl methacrylate (GMA) is added to the dispersion at 100° C. and stirred for 8 hours. The solid is separated and thoroughly washed with DMAC and then with methanol and dried. The infrared evaluation of the separated, modified PTFE micropowder showed that poly-GMA with reactive epoxy groups chemically coupled to the PTFE was present. In a melt modification reaction of the PTFE-{poly-GMA}-powder with PBT containing carboxyl groups in a laboratory kneader, it was possible to detect a grafting/coupling with PBT.

The PTFE material thus modified was incorporated at 10% by weight into PBT in the laboratory kneader and the tribological properties were examined. In a first approximation the friction coefficients in the block/ring test were comparable to the material of unmodified PTFE powder and PBT; in contrast, the modified PTFE material in the compound with PBT showed a reduction of the wear value to 40% compared to the physical mixture with PBT.

### EXAMPLE 9

Modification of PTFE emulsion polymer with ε-caprolactam and GMA

In a liter flask 100 g of the PTFE emulsion polymer (TF 2025, from Dyneon, irradiated with 500 kGy) is dispersed/stirred in 500 ml ε-caprolactam in a melt/solution, degassed and rinsed with high-purity nitrogen.

20 g glycidyl methacrylate (GMA) is added to the dispersion at 100° C. and stirred for 8 hours. The dispersion is heated to 240° C. and stirred for 4 hours exposed to nitrogen. The solid is separated and thoroughly washed with DMAc and then with methanol and dried. The infrared evaluation of the separated, modified PTFE micropowder showed that poly-GMA with reactive epoxy groups and oligoamide chemically coupled to the PTFE was present. In a melt modification reaction with novolak in a laboratory kneader it was possible to detect a grafting/coupling with the novolak.

The processing of this PTFE-novolak system into test specimens and the tribological examination showed that the material had a comparable friction coefficient and a high wear resistance compared to comparative example 2, in which, however, epoxide resin forms the matrix.

### EXAMPLE 10

Modification of PTFE emulsion polymer with p-aminophenol

In a liter flask 100 g of the PTFE emulsion polymer (TF 2025 from Dyneon, freshly irradiated with 500 kGy in the presence of atmospheric oxygen) is dispersed/stirred in 500 ml DMAc, degassed and rinsed with high-purity nitrogen. 20 g p-aminophenol is added and stirred for 4 hours at 100° C. The solid product is separated and washed first with DMAc and then with methanol and dried. The infrared evaluation of the separated modified PTFE micropowder yielded the p-aminophenol chemically coupled as amide on the PTFE with free phenol groups.
(a) In a first modification reaction, GMA was coupled, which then as proof reacts in a copolymerization with styrene. As grafting/coupling, it was possible to detect polystyrene absorptions by means of infrared spectroscopy.
The pressed PTFE-polystyrene products showed tribologically very low friction coefficients, comparable to pure PTFE and the materials from comparative example 1, and a high wear resistance.
(b) In a second modification reaction, the PTFE powder to which the p-aminophenol was coupled, together with 4,4′-difluorodiphenyl sulfone and 4,4′-dihydroxydiphenyl ether was reacted to polysulfone with the addition of a condensation catalyst according to known direction. After the separation of the soluble constituents of polysulfone, it was possible to detect polysulfone absorption bands on the insoluble PTFE solid product by means of infrared spectroscopy, i.e., the polysulfone was present chemically coupled to the PTFE.

The pressed PTFE-polysulfone products had tribologically very low friction coefficients, comparable to pure PTFE, and a very high wear resistance.

### EXAMPLE 11

Modification of PTFE emulsion polymer with 4,4′-diaminodiphenyl ether

In a liter flask 100 g of the PTFE emulsion polymer (TF 2025, from Dyneon, freshly irradiated with 500 kGy in the presence of atmospheric oxygen) is dispersed/stirred in 500 ml DMAc, degassed and rinsed with high-purity nitrogen. 20 g of 4,4′-diaminodiphenyl ether is added and stirred for 4 hours at 100° C. The solid product is separated and washed first with DMAc and then with methanol and dried.

The infrared evaluation of the separated, modified PTFE micropowder yielded the 4,4′-diaminodiphenyl ether chemically coupled as an amide to the PTFE.

In the consecutive reactions, as proof
(a) GMA was coupled to the modified PTFE micropowder, to which GMA styrene was then grafted in a copolymerization, and
(b) Phenyl isocyanate, forming a urea group as a model for the later covalent incorporation in polyureas was added
could be detected by means of infrared spectroscopy.

In a subsequent modification according to known direction the PTFE product was used in a polyimide synthesis of diisocyanate (mixture MDI with TDI=80:20) and carboxylic acid dianhydride (benzophenonetetracarboxylic acid dianhydride) in dimethylacetamide (DMAc). After separation of the soluble polyimide constituents, it was possible to detect polyimide coupled to the PTFE by means, of infrared spectroscopy. The pressed PTFE-polyimide products exhibited tribologically very low friction coefficients, comparable to pure PTFE, and an extremely high wear resistance.

### EXAMPLE 12

Modification of PTFE emulsion polymer with 1,6-aminohexanol

In a liter flask 100 g of the PTFE emulsion polymer (TF 2025 from Dyneon, freshly irradiated with 500 kGy in the presence of atmospheric oxygen) is dispersed/stirred in 500 ml DMAc, degassed and rinsed with high-purity nitrogen.

20 g 1,6-aminohexanol is added and stirred for 4 hours at 100° C. The solid product is separated and washed first with DMAc and then with methanol and dried.

The infrared evaluation of the separated, modified PTFE micropowder yielded the 1,6-aminohexanol chemically coupled as an amide to the PTFE. In a consecutive reaction, as proof phenyl isocyanate was coupled, which then could be detected by means of infrared spectroscopy as urethane.

The PTFE powder thus modified was reacted with TPU in the melt in a laboratory kneader. After the separation of the soluble TPU constituents, it was possible to detect by means of infrared spectroscopy chemically coupled TPU, which could not be separated from the PTFE by dissolution.

The PTFE powder thus modified was further reacted in the melt in a laboratory kneader with PBT (1), with PET (2) and also with polyester-ester elastomer (3). After the separation of the soluble polyester constituents, in every case polyester coupled to PTFE could be detected by means of infrared spectroscopy.

The pressed materials from these tests exhibited tribologically very low friction coefficients, comparable to pure PTFE, and a very good wear resistance compared to the pure base materials not modified with PTFE.

### EXAMPLE 13

Modification of PTFE emulsion polymer with MDI (4,4′-Diphenylmethane diisocyanate)

In a liter flask 100 g of the PTFE emulsion polymer (TF 2025 from Dyneon, freshly irradiated with 500 kGy in the presence of atmospheric oxygen) is tempered so that primarily —COOH groups are present, dispersed/stirred in 500 ml NMP (N-methyl pyrrolidone), degassed and rinsed with high-purity nitrogen. 20 g MDI is added and stirred for 8 hours at 200° C., then 10 g ε-caprolactam is added to block the free isocyanate groups. The solid product is separated and washed first with DMAc and then with acetone and dried.
(a) 30% by weight of the modified PTFE powder is reacted with TPU in melt in a laboratory kneader and subsequently the soluble TPU is separated.

In addition to the PTFE absorptions, TPU was also detected on the insoluble constituent by means of infrared spectroscopy.
The tribological examinations yielded very low friction coefficients, comparable to pure PTFE, and a very good wear resistance compared to the pure base material not modified with PTFE.
(b) The modified PTFE powder is dispersed in NMP and stirred with MDI and trimellitic acid anhydride according to a known method to polyamide imide synthesis (PAI) first for four hours at 140° C. and then another 8 hours at 180° C. exposed to nitrogen and with reflux cooling. After the separation of the soluble PAI constituents, it was possible to detect PAI chemically coupled to the PTFE residue.

The tribological examinations yielded very low friction coefficients, comparable to pure PTFE, and a very good wear resistance compared to the pure PAI not modified with PTFE.

### EXAMPLE 14

Modification of PTFE emulsion polymer with ε-caprolactam with subsequent anionic PA polymerization

In a liter flask 100 g of the PTFE emulsion polymer (TF 2025 from Dyneon, irradiated with 500 kGy), primarily with COF groups, is dispersed/stirred in a melt/solution in 500 ml high-purity ε-caprolactam, degassed and rinsed with high-purity nitrogen. 0.5 g calcium hydride is added to the system during stirring.

The dispersion is slowly heated up to 180° C. The anionic polymerization takes place during the heating of the reaction system.

The PTFE-PA-6 product is separated.

For the analysis, 2 g PTFE-PA-6 solid product is dissolved in formic acid and the uncombined PA-6 matrix is separated. This operation is repeated 4 times. The solid product is washed with methanol and dried. The infrared evaluation of the separated, modified PTFE micropowder showed that chemically coupled PTFE polyamide is present.

The PTFE-PA-6 material thus produced via anionic polymerization was examined with respect to the tribological properties. In the first approximation the friction coefficients in the block/ring test were comparable to pure PTFE and the material from comparative example 1; in contrast, this PTFE-PA-6 (cast polyamide) material showed a reduction of the wear value to 45% compared to the physical mixture (comparative example 1).

### EXAMPLE 15

Modification of PTFE emulsion polymer to chemically coupled PTFE polyamide imide material (PTFE-PAI)

In a 500 ml three-neck flask 50 g polyamide imide (Torlon, Solvay) is dissolved in 250 ml NMP (dried) while being stirred at 100° C. 10 g PTFE emulsion polymer (TF 2025 from Dyneon, freshly irradiated with 500 kGy in the presence of atmospheric oxygen) is added to the solution and dispersed/stirred, degassed and rinsed with high-purity nitrogen. The dispersion is subsequently stirred with reflux heating and inert gas atmosphere for 8 hours at 200° C. After cooling to approx. 50° C., the solid product is separated by precipitation in methanol and dried.

To prove the coupling, approx. 5 g of the precipitated solid product is stirred in 20 ml NMP at 100° C. After cooling, it is centrifuged and the supernatant solvent is decanted. The separation of the soluble PAI constituents is repeated 5 times after this procedure. Then the residue is filtered through a frit and washed with NMP and subsequently with acetone and dried. The infrared evaluation of the separated modified PTFE micropowder showed that PAI is present coupled to the PTFE in a non-extractable manner.

The pressed PTFE polyamide imide product exhibited tribologically very low friction coefficients, comparable to pure PTFE, and a very high wear resistance.

### EXAMPLE 16

Modification of PTFE emulsion polymer to chemically coupled PTFE polyamide imide material through direct synthesis

In a 500 ml three-neck flask 250 g NMP (dried) is presented and while being stirred at room temperature 10 g PTFE suspension polymer (TF 1750 from Dyneon, freshly irradiated with 1000 kGy in the presence of atmospheric oxygen) and 63.5 g MDI (4,4′-Diphenylmethane diisocyanate) are added and dispersed/stirred, degassed and rinsed with high-purity nitrogen. The dispersion is subsequently stirred in an inert gas atmosphere for 1 hour at 140° C. Subsequently 48 g TMAn (trimellitic anhydride) is added and the dispersion is gradually heated to 180° C. while being stirred in an inert gas atmosphere and is stirred for 8 hours. After cooling to approx. 50° C., the solid product is separated by precipitation in methanol and dried.

To prove the coupling, analogously to example 15, approx. 5 g of the precipitated solid product is stirred in 20 ml NMP at 100° C. After cooling, it is centrifuged and the supernatant solvent is decanted. The separation of the soluble PAI constituents is repeated 5 times after this procedure. Then the residue is filtered through a frit and washed with NMP and subsequently with acetone and dried. The infrared evaluation of the separated modified PTFE micropowder showed that PAI is present coupled to the PTFE in a non-extractable manner.

As in example 15, the pressed PTFE polyamide imide product exhibited tribologically very low friction coefficients, comparable to pure PTFE, and a very high wear resistance.

### EXAMPLE 17

Modification of PTFE emulsion polymer to chemically coupled PTFE polyimide material (PTFE-PI)

In a 500 ml three-neck flask 50 g polyimide (produced from 3,3′,4,4′-benzophenonetetracarboxylic acid dianhydride and a mixture of 4,4′-diphenylmethane diisocyanate and toluene diisocyanate in a ratio 20:80 in NMP) is dissolved in 250 ml NMP (dried) while being stirred at 100° C. 10 g PTFE emulsion polymer (TF 2025 from Dyneon, freshly irradiated with 500 kGy in the presence of atmospheric oxygen) is added and dispersed/stirred, degassed and rinsed with high-purity nitrogen. The dispersion is subsequently stirred for 8 hours at 200° C. with reflux heating and in an inert gas atmosphere. After cooling to approx. 50° C., the solid product is separated by precipitation in methanol and dried.

To prove the coupling, approx. 5 g of the precipitated solid product is stirred in 20 ml NMP at 100° C. After cooling, it is centrifuged and the supernatant solvent is decanted. The separation of the soluble polyamide constituents is repeated 5 times after this procedure. Then the residue is filtered through a frit and washed with NMP and subsequently with acetone and dried. The infrared evaluation of the separated modified PTFE micropowder showed that polyamide is present coupled to the PTFE in a non-extractable manner.

The pressed PTFE polyimide product exhibited tribologically very low friction coefficients, comparable to pure PTFE, and a very high dimensional stability under heat and wear resistance.

### EXAMPLE 18

Modification of PTFE emulsion polymer to chemically coupled PTFE polyimide material (PTFE-PI) through direct synthesis

In a 500 ml three-neck flask while being stirred 5 g 4,4′-diphenylmethane diisocyanate (MDI), 13,9 g and toluene diisocyante (TDI; mixture of 2,4-TDI:2,6-TDI=80:20) and 10 g emulsion polymer (TF 2025 from Dynon, freshly irradiated with 1000 kGy in the presence of atmospheric oxygen) are incorporated into 250 ml NMP (dried, distilled) and stirred for one hour at 160° C. during degassing with high-purity nitrogen. 32.2 g 3,3′,4,4′-benzophenonetetracarboxylic acid dianhydride is subsequently added to the dispersion. The dispersion is slowly heated to 180° C. during stirring and degassing with high-purity nitrogen and stirred at 180° C. for 14 hours. After cooling to approx. 50° C., the solid product is separated by precipitation in methanol and dried.

To prove the coupling, approx. 5 g of the precipitated material is stirred in 20 ml NMP at 100° C. After cooling, it is centrifuged and the supernatant solvent is decanted. The separation of the soluble polyimide constituents is repeated 5 times after this procedure. Then the residue is filtered through a frit and washed with NMP and subsequently with acetone and dried. The infrared evaluation of the separated modified PTFE micropowder showed that polyimide is present coupled to the PTFE in a non-extractable manner.

As in example 16, the pressed PTFE polyimide product exhibited tribologically very low friction coefficients, comparable to pure PTFE, and a very high dimensional stability under heat and wear resistance.

### EXAMPLE 19

Modification of PTFE emulsion polymer to chemically coupled PTFE polyetheretherketone (PTFE-PEEK) through direct synthesis A

In a 250 ml three-neck flask with stirrer, gassing with high-purity nitrogen and microstill, in 150 ml NMP (N-methylpyrrolidone) 5 g p-aminophenol-modified PTFE powder (produced according to example 10), 22.05 g 4,4′-difluorobenzophenone, 25.45 g bis-silylated hydroquinone and in the excess 15 g nonaqueous potassium carbonate in the presence of cesium fluoride as catalyst are presented and reacted according to known direction of the PEEK production.

Analysis: 30 ml of the dispersion is centrifuged after cooling, the supernatant solution decanted and agitated with NMP and centrifuged again. Subsequently, the solid is agitated with methanol, suctioned and dried. The solid substance is stirred into concentrated sulfuric acid and stirred for 4 hours at 50° C. and allowed to stand overnight (sulfonation of the PEEK chains). The dispersion is carefully filtered through a frit and washed with semiconcentrated sulfuric acid. After the receiver has been changed, the residue is thoroughly washed with water and methanol and dried. The infrared evaluation of the separated solid product showed that PEEK (sulfonated) chemically coupled to the PTFE is present that was not extractable. In a comparative reaction in which instead of the modified PTFE micropowder only the thermally decomposed PTFE micropowder TF 9205 from Dyneon was used, after separation and purification of the solid product it was possible by means of infrared spectroscopy to detect only the pure PTFE, which indirectly confirms the chemical coupling.

The greater part of the dispersion from the batch after cooling to approx. 50° C. is precipitated in methanol/water (1:1), suctioned, washed with water, methanol and acetone and dried.

The pressed PTFE-PEEK product exhibited tribologically very low friction coefficients, comparable to pure PTFE, and a very high dimensional stability under heat and wear resistance.

### EXAMPLE 20

Modification of PTFE emulsion polymer to chemically coupled PTFE polyetheretherketone (PTFE-PEEK) through direct synthesis B.

In a 250 ml three-neck flask with stirrer, gassing with high-purity nitrogen and microdistillation equipment, in 150 ml NMP 5 g freshly irradiated, not aftertreated PTFE micropowder (from PTFE emulsion polymer TF 2025 from Dyneon, freshly irradiated with 500 kGy in the presence of atmospheric oxygen, with primarily carbonyl fluoride groups on the PTFE), 22.05 g 4,4′ difluorobenzophenone, 25.45 g bis-silylated hydroquinone and in the excess 15 g nonaqueous potassium carbonate in the presence of cesium fluoride as catalyst are presented and reacted according to known direction of the PEEK production.

Analysis: Working up according to example 19; the infrared evaluation of the separated solid product showed that, analogous to example 19, (sulfonated) PEEK chemically coupled to the PTFE, which PEEK was not extractable.

The greater part of the dispersion is worked up according to example 19.

The pressed PTFE-PEEK product exhibited tribologically very low friction coefficients, comparable to pure PTFE, and a very high dimensional stability under heat and wear resistance.

### EXAMPLE 21

Modification of PTFE emulsion polymer to chemically coupled PTFE polyetheretherketone (PTFE-PEEK)

In a 500 ml three-neck flask with stirrer, gassing with high-purity nitrogen and microdistillation equipment, 30 g PEEK is dissolved in 150 ml diphenyl sulfone at 320° C. while being stirred. The solution is cooled to approx. 270° C. and 5 g freshly irradiated, not aftertreated PTFE micropowder (from PTFE emulsion polymer TF 2025 from Dyneon, freshly irradiated with 500 kGy in the presence of atmospheric oxygen, with primarily carbonyl fluoride groups on the PTFE) is added, stirred for 2 hours at 270° C. and again for 1 hour at 320° C. The polymer precipitates during cooling.

Analysis: After the dispersion is cooled to approx. 180° C., approx. 100 ml NMP is added and 50 ml of this dispersion is subsequently worked up as in example 19. The infrared evaluation of the separated solid product yielded (sulfonated) PEEK chemically coupled to the PTFE, which was not extractable.

The greater part of the dispersion diluted with NMP is worked up as in example 19.

The pressed PTFE-PEEK product exhibited tribologically very low friction coefficients, comparable to pure PTFE, and a very high dimensional stability under heat and wear resistance.

1. Modified perfluoroplastic, comprising a perfluoropolymer including a surface modified under influence of oxygen radiation-chemically or plasma-chemically, the surface simultaneously having —COOH and/or —COF groups and reactive perfluoroalkyl-(peroxy-) radical centers, and additional low-molecular and/or oligomeric and/or polymeric substances and/or olefinically unsaturated monomers and/or olefinically unsaturated oligomers and/or olefinically unsaturated polymers or mixtures thereof are coupled via some or all of the groups and/or to some or all of the centers.

2. The modified perfluoroplastic according to claim 1, wherein the perfluoropolymer is radiation-chemically modified under influence of oxygen.

3. The modified perfluoroplastic according to claim 2, wherein the perfluoropolymer is radiation-chemically modified with a radiation dose of more than 50 kGy.

4. The modified perfluoroplastic according to claim 2, wherein the perfluoropolymer is radiation-chemically modified with a radiation dose greater than 100 kGy.

5. The modified perfluoroplastic according to claim 1, wherein the perfluoropolymer is polytetrafluoroethylene.

6. The modified perfluoroplastic according to claim 1, wherein the following reactions are radical reactions and/or substitution reactions and/or addition reactions.

7. The modified perfluoroplastic according to claim 6, wherein olefinically unsaturated monomers and/or olefinically unsaturated oligomers or olefinically unsaturated polymers are coupled to the reactive perfluoroalkyl-(peroxy-) radical centers through (co-) polymerization and/or through grafting.

8. The modified perfluoroplastic according to claim 6, wherein at least one substance is coupled to ester and/or amide bonds formed via reactions with the —COOH and/or —COF groups.

9. The modified perfluoroplastic according to claim 8, wherein at least one additional functional group is bonded to the at least one substance coupled via ester and/or amide bonds.

10. The modified perfluoroplastic according to claim 6, wherein via reactions with the —COOH— and/or —COF groups, aliphatic amino compounds and/or aromatic amino compounds and/or alkylaryl-amino compounds are coupled to at least one further primary and/or secondary amino group or at least one further reactive or reactively modifiable or reactively activatable functional group.

11. The modified perfluoroplastic according to claim 10, wherein as further reactive or reactively modifiable or reactively activatable functional group carboxylic acid anhydride, carboxylic acid anhydride derivative, which can also be recycled as dicarboxylic acid and/or carbonic half-ester compound to anhydride, —COOH, —CO-halogen, —COOR, —CO—OOR, —O—CO—OR, —SO₃H, —SO₂NRR*, —SO₂N₃, —SO₂-halogen, aliphatic and/or aromatic —OH, aliphatic and/or aromatic —SH, (meth-)acrylic ester, allyl and other olefinically unsaturated polymerizable compounds and/or polymers, cyanohydrin, —NCO, —NH—CO—OR, —NH—CS—OR, —NR*—CO—NR**R***, —N*—CS-R**R***, —CHO, —COR are coupled, and R, R*, R** and/or R*** are alkyl-Xₘ, aryl-Xₙ or alkyaryl-X_{O}, or R, R*, R** and/or R*** bonded to N are H, and X is the same or also different functional groups and with m, n and o being numbers greater than or equal to 0.

12. The modified perfluoroplastic according to claim 6 wherein olefinically unsaturated monomers and/or olefinically unsaturated oligomers or olefinically unsaturated polymers are coupled to the reactive perfluoroalkyl-(peroxy-) radical centers by (co-)polymerization and/or by grafting and at least one substance is coupled to ester and/or amide bonds produced via reactions with the —COOH and/or —COF groups and via reactions with the —COOH— and/or —COF groups, aliphatic amino compounds and/or aromatic amino compounds and/or alkylaryl-amino compounds are coupled to at least one further primary and/or secondary amino group or at least one further reactive or reactively modifiable or reactively activatable functional group.

13. Method for producing a modified perfluoroplastic comprising a perfluoropolymer including a surface modified under influence of oxygen radiation-chemically or plasma-chemically, the surface simultaneously having —COOH and/or —COF groups and reactive perfluoroalkyl-(peroxy-) radical centers, and additional low-molecular and/or oligomeric and/or polymeric substances and/or olefinically unsaturated monomers and/or olefinically unsaturated oligomers and/or olefinically unsaturated polymers or mixtures thereof are coupled via some or all of the groups and/or to some or all of the centers, the method comprising reacting a perfluoropolymer that is radiation-chemically or plasma-chemically modified under influence of oxygen, which perfluoropolymers simultaneously exhibit —COOH and/or —COF groups and reactive perfluoroalkyl-(peroxy-) radical centers, with low-molecular and/or oligomeric and/or polymeric substances and/or olefinically unsaturated monomers and/or olefinically unsaturated oligomers and/or olefinically unsaturated polymers by substitution reactions and/or by addition reactions and/or by radical reactions.

14. The method according to claim 13, wherein the perfluoropolymer is radiation-chemically modified.

15. The method according to claim 13, wherein the perfluoropolymer is radiation-chemically modified with a radiation dose greater than 50 kGy.

16. The method according to claim 13, wherein the perfluoropolymer is radiation-chemically modified with a radiation dose greater than 100 kGy.

17. The method according to claim 13, wherein the perfluoropolymer comprises PTFE in compact or powder form.

18. The method according to claim 13, wherein the radiation-chemically modified perfluoropolymer powder is treated through subsequent tempering at low temperatures yielding the —COF groups and the reactive perfluoroalkyl-(peroxy-)radical centers.

19. The method according to claim 18, wherein the radiation-chemically modified perfluoropolymer powder is treated by subsequent tempering with humid air.

20. The method according to claim 13, wherein the radiation-chemically modified perfluoropolymer is reacted with reactive perfluoroalkyl-(peroxy-) radical centers with olefinically unsaturated monomers and/or olefinically unsaturated oligomers and/or olefinically unsaturated polymers.

21. The method according to claim 13, wherein the —COOH and/or —COF groups are reacted at temperatures >150° C. with low-molecular and/or oligomeric and/or polymeric substances that contain primary and/or secondary amino groups and/or hydroxy groups and/or amide groups and/or urea groups and/or isocyanate groups and/or blocked/protected isocyanate groups and/or urethane groups and/or uretdione groups, with at least one other functional group in the (macro-) molecule, which are capable of chemical consecutive reactions.

22. The method according to claim 21, wherein the —COOH and/or —COF groups are reacted at temperatures >150° C. in a reaction with low-molecular and/or oligomeric and/or polymeric substances that contain primary and/or secondary amino groups and/or hydroxy groups, with at least one other functional group in the (macro-) molecule, which are capable of chemical consecutive reactions.

23. The method according to claim 13, wherein the —COOH and/or —COF groups are reacted at temperatures >150° C. in a reaction with low-molecular and/or oligomeric and/or polymeric substances that contain hydroxy groups and/or epoxy groups, with at least one other functional group in the (macro-) molecule, which are capable of chemical consecutive reactions.

24. The method according to claim 13, wherein the —COF groups are reacted with a lactam compound or an alcohol compound.

25. The method according to claim 13, wherein the —COOH and/or —COF groups are reacted at temperatures ≧200° C. with low-molecular and/or oligomeric and/or polymeric substances that contain amide groups and/or urea groups and/or isocyanate groups and/or blocked/protected isocyanate groups and/or urethane groups and/or uretdione groups, with at least one other functional group in the (macro-) molecule, which are capable of chemical consecutive reactions.

26. The method according to claim 13, wherein the radiation-chemically modified perfluoropolymer powder is reacted with reactive perfluoroalkyl-(peroxy-)radical centers with olefinically unsaturated monomers and/or olefinically unsaturated oligomers and/or olefinically unsaturated polymers, and the —COOH and/or —COF groups are reacted at temperatures >150° C. with low-molecular and/or oligomeric and/or polymeric substances that contain primary and/or secondary amino groups and/or hydroxy groups and/or amide groups and/or urea groups and/or isocyanate groups and/or blocked/protected isocyanate groups and/or urethane groups and/or uretdione groups, with at least one other functional group in the (macro-)molecule, which are capable of chemical consecutive reactions, or the —COOH and/or —COF groups are reacted at temperatures >150° C. in a reaction with low-molecular and/or oligomeric and/or polymeric substances that contain hydroxy groups and/or epoxy groups, with at least one other functional group in the (macro-)molecule, which are capable of chemical consecutive reactions, or the —COF groups are reacted with a lactam compound or an alcohol compound.
